(19) United States
(12) Patent Application Publication
(10) Pub. No.: US 2009/0058043 A1
(43) Pub. Date: Mar. 5, 2009

(54) Three point hitch alignment tool

(76) Inventor: Arthur Shannon, Honeybrook, PA (US)

Correspondence Address: Arthur Shannon, 1110 Chestnut Tree Rd, Honeybrook, PA, 19344-9644, US

(21) Appl. No.: 11/895,446

(22) Filed: Aug. 24, 2007

(51) Int. Cl. B60D 1/36

(52) U.S. Cl. 280/477

(57) ABSTRACT

The present invention is used to align the holes of a 3 pint hitch implement with a primary device, for example, a tractor. Many times the points of attachment between the implement and the primary device are difficult to align for easy insertion of a hitch pin. The present invention is a system and a method to utilize an alignment tool which is tapered on one end and with an indentation on the other end for inserting a tip of the hitch pin. The tool is inserted into the hitch pin holes of the implement and the primary device allowing for the manipulation of the holes with the tapered portion and finely aligning the holes and finally pushing the alignment tool through the holes with said hitch pin.

### BACKGROUND OF THE INVENTION

The present invention relates to users of tractors or any agricultural equipment which tows or pushes an attached apparatus, such as a gang mower or tiller plow. The vast majority of tractor and agricultural equipment utilize a three point hitch. A three point hitch usually consists of three major components, a left lower arm, a right lower lift arm and a top link assembly. The arms and link assemblies are usually adjustable to a central body as the top link assembly and the left and right lower arms have threaded ends with balls, one of which attaches to the tractor, and the other which attaches to the implement. For instance, to move plants at a nursery, an operator would securely connect a tractor to a wagon via a hitch pin assembly. The tractor operator has to climb down from the seat to lift up the wagon pole or tongue, position it in exact alignment with the drawbar, and drop the hitch pin in the hopefully aligned three point hitch holes. Sometimes workers use a jack or blocks to hold up the heavy wagon tongue and often drivers recruit a helper to point stand behind the tractor and do the hitching. If a tractor operator is very skilled, he or she can back up to the wagon precisely so a minimum of lifting and maneuvering is needed to hook up the tongue. But, there is always at least some fine tuning of the hitch and the hitch pin, usually by brute force.

### SUMMARY

The present invention is used to align the holes of a 3 pin hitch implement with a primary device, for example, a tractor. Many times the points of attachment between the implement and the primary device are difficult to align for easy insertion of the hitch pin. The present invention is a system and a method to utilize an alignment tool which is tapered on one end with an indentation on the other end for the tip of the hitch pin.

The insertion of the tapered end into the hitch pin holes of the implement and the primary device allows for the manipulation of the holes, by prying with the tool and running the tapered portion of the tool through the holes, for the hitch pin insertion preparation. After acquiring a course alignment with prying, the tapered portion will finely align the holes by way of pushing the alignment tool through the holes with the hitch pin.

### BRIEF DESCRIPTION OF THE DRAWINGS

FIG. 1 is a side view of a tapered tool which is utilized in one embodiment of the present invention.

FIG. 2 shows two hitch pin holes slightly out of alignment.

FIG. 3 illustrates aligning an arm with a ball socket to a stationary support of a towed apparatus.

### DETAILED DESCRIPTION OF THE PREFERRED EMBODIMENTS

The above and other objects, features and other advantages of the present invention will be more clearly understood from the following detailed description taken in conjunction with the accompanying drawings. Other objects, advantages and novel features of this invention will become apparent from the following detailed description when considered in conjunction with the accompanying drawings.

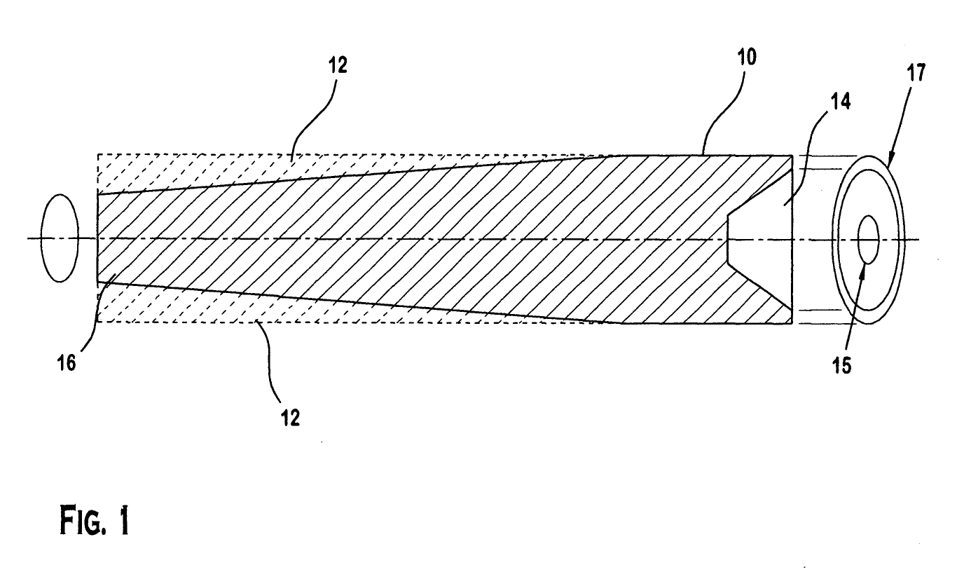

A first embodiment of the present invention will be described in conjunction to the figures described herewith in. Referring to FIG. 1 a metal rod 10 is tapered 12 to a semi-pointed end 16. The other end of the metal rod 10 has a conic wedge 14 machined out of the other end. The largest circumference 17 of the conic wedge 14 has is about ⅛^{th} of an inch edge, while the flattened top portion of the conic wedge 14 is up to about ½ of the diameter of the metal rod 10.

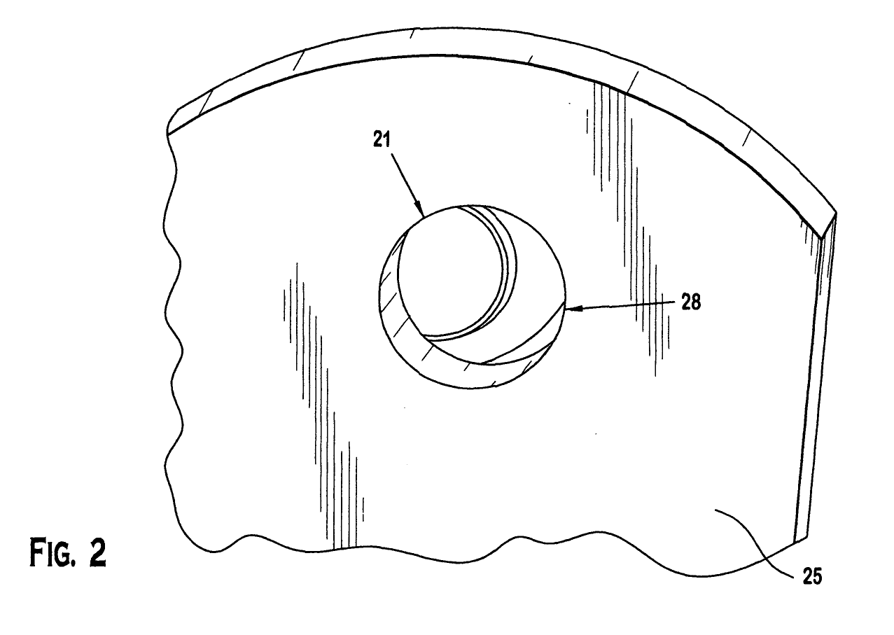

The metal rod 10 is inserted by the tapered end 16 into the hitch pin holes of the implement. For example, referring to FIG. 2., the metal rod 10 is inserted into hole 21 and hole 23 of the hitch. The metal rod 10 us then manipulated and the holes 21 and 23 are repositioned by prying with the tool and running the tapered portion of the tool through the holes. After acquiring a course alignment with prying, the tapered portion 12 will finely align the holes 21 and 23 by way of pushing the alignment tool 10 through the holes with the hitch pin.

The present invention entails an alignment tool which is a cylindrical steel rod of appropriate diameter for the category class of hitch it is to be used on. An example of an embodiment utilizes an eight inch rod. One end has a ⅜-inch point while the six inches of shaft are tapered from the point. The remaining two inches are the full diameter of the rod and is slightly smaller than the hitch pin. At the full diameter end there is a conical indentation into the end of the rod for the tip of the hitch pin. This conical indention is approximately ¾-inch deep. The indentation diameter starts at approximately ⅛-inch smaller than the full rod and the top of the conical section is located in the rod at a depth of approximately ¾-inch. The top of the conical section can be arced or flat.

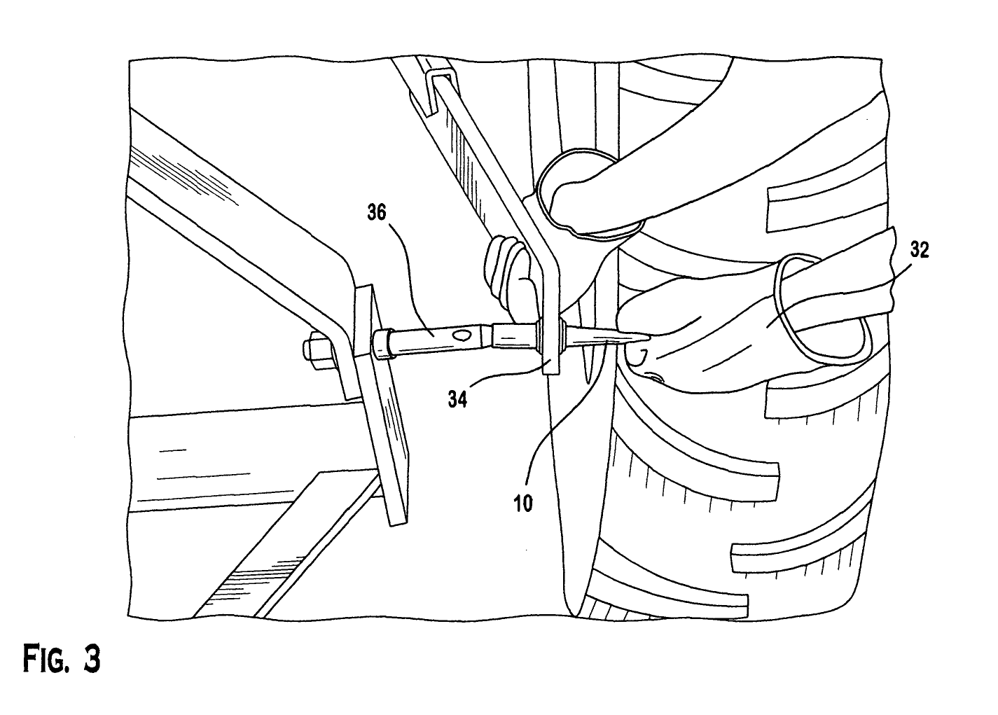

Now referring to FIG. 3., another embodiment of the present invention. The metal rod 10 is placed on a mounting pin 36 and also fed through an arm with a ball socket 34. The human hand 32 manipulates the metal rod 10 to align the ball socket 34 and easily slides the ball socket 34 unto the mounting pin 36.

Of concern to all users is safety, check the owner's manual for safe hitching points. Usually the drawbar is the safest place to hitch a wagon, since a tractor can flip over backwards if the load is hitched higher up such as from the seat bracket, axle, or 3-point lift arms. Dangling, loose chains can catch on a stump or rock and also cause a tractor to flip.

It is to be understood that the above described embodiments of the invention is illustrative only and that modifications thereof may occur to those skilled in the art. Accordingly, this invention is not to be regarded as limited to the embodiment disclosed herein.

What is claimed is:

1. A rod to aid with the insertion of a hitch pin with a first end tapered to a point; said rod also includes a bevel into a second end of rod point having an arc shape to match the diameter of said hitch pin.

2. A method to align hitch pin holes, comprising:
inserting a tapered rod into a first hitch pin hole;
maneuvering said tapered rod to align said first hitch pin hole with a second hitch pin hole;
placing said tapered rod into said second hitch pin hole thereby placing tapered pin into both first hitch pin hole and second hitch pin hole.
